(19) United States
(12) Patent Application Publication
(10) Pub. No.: US 2026/0142206 A1
(43) Pub. Date: May 21, 2026

(54) INPUT ASSEMBLY FOR A POWER TRANSFER UNIT

(71) Applicant: Robert Bosch GmbH, Stuttgart (DE)

(72) Inventor: He Zhang, Suzhou (CN)

(21) Appl. No.: 19/390,593

(22) Filed: Nov. 16, 2025

(30) Foreign Application Priority Data
Nov. 18, 2024 (CN) 2024 2280 1809.6

(51) Int. Cl. H01M 8/04858; B60L 50/70; H01M 8/04537

(52) U.S. Cl. CPC H01M 8/04858; H01M 8/04589; B60L 50/70; H01M 2250/20

(57) ABSTRACT

An input assembly for a power transfer unit is disclosed, which includes a set of busbars consisting of a positive busbar and a negative busbar, each of the positive busbar and the negative busbar including an input terminal electrically connected to a fuel cell stack to receive current from the stack, an output terminal electrically connected to the power transfer unit to transmit current to the power transfer unit, and a main body located between the corresponding input terminal and output terminal. The input assembly further includes an insulating housing that surrounds the corresponding main body of the positive busbar and the negative busbar and at least partially fills the gap between the positive busbar and the negative busbar. The functional elements of the input assembly are connected to the insulating housing and/or the set of busbars. The input assembly for a power transfer unit of the present disclosure has the advantages of saving space and being easy to assemble and maintain.

This application claims priority under 35 U.S.C. § 119 to application no. CN 2024 2280 1809.6, filed on Nov. 18, 2024 in China, the disclosure of which is incorporated herein by reference in its entirety.

The present disclosure relates to power transfer units for fuel cells. In particular, it relates to an input assembly for a power transfer unit.

### BACKGROUND

Power transfer units (PTUs) are widely used for power and signal transmission in fuel cells. Typically, a set of busbars (usually in the form of copper bars), comprising a positive busbar and a negative busbar, is arranged between the fuel cell stack and the power transfer unit. This set of busbars transmits the current from the fuel cell stack to the power transfer unit, and the power transfer unit can transmit the current to various actuators powered by the fuel cell as needed. The above set of busbars is arranged at the input terminal of the power transfer unit. Considering the insulation requirements between the positive and negative busbars and ease of assembly, this set of busbars is usually embedded and formed into an assembly, and is therefore also called the input assembly of the power transfer unit.

Today, power transfer units are designed with more and more sub-components to achieve different functions, and their structures are becoming more complex. The installation and positioning of the various sub-components of the power transfer unit in the prior art do not make full use of the space in which the input assembly is located, i.e., the positive and negative busbars, resulting in an insufficiently compact arrangement of the input assembly, which in turn leads to the entire power transfer unit occupying a large space. In addition, the assembly and maintenance of an input assembly with a complex structure also present difficulties for operators.

Thus, there is a need for an input assembly for a power transfer unit that that overcomes the shortcomings of the prior art, such as complex structure and difficulty in assembly and maintenance.

### SUMMARY

To achieve the above objectives, the present disclosure proposes an input assembly for a power transfer unit, which comprises a set of busbars consisting of a positive busbar and a negative busbar, each of the positive busbar and the negative busbar comprising an input terminal electrically connected to a fuel cell stack to receive current from the stack, an output terminal electrically connected to the power transfer unit to transmit current to the power transfer unit, and a main body located between the corresponding input terminal and output terminal. The input assembly further comprises an insulating housing that surrounds the corresponding main body of the positive busbar and the negative busbar and at least partially fills the gap between the positive busbar and the negative busbar, wherein the functional elements of input assembly are connected to the insulating housing and/or the set of busbars.

The functional elements of the input assembly may comprise a current sensor attached to the insulating housing for measuring the output current of cell stack, the current sensor comprising a sensor body formed with a coil opening and a coil for sensing current being arranged inside the sensor body around the coil opening, wherein the coil opening is arranged adjacent to the stack and one of the positive busbar and the negative busbar passes through the coil opening.

A step may be provided in the main body of the corresponding busbar passing through the coil opening in the set of busbars near the input terminal of the corresponding busbar, the step being configured to protrude in a direction away from the stack and the coil opening being arranged such that the step passes through the coil opening.

The positive busbar may comprise a positive busbar first extension extending from the main body thereof, the negative busbar may comprise a negative busbar first extension extending from the main body thereof, and the functional elements of the input assembly may comprise a stack short-circuit protection device, the stack short-circuit protection device being attached to the insulating housing and electrically connected between the positive busbar and the negative busbar via the positive busbar first extension and the negative busbar first extension.

The positive busbar may comprise a positive busbar second extension extending from the main body thereof and a positive busbar third extension extending from the input terminal thereof, the negative busbar may comprise a negative busbar second extension extending from the main body thereof, and the functional elements of the input assembly may comprise an electromagnetic shielding device, the electromagnetic shielding device comprising an X capacitor electrically connected between the positive busbar second extension and the negative busbar, a first set of Y capacitors electrically connected between the positive busbar third extension and ground, and a second set of Y capacitors electrically connected between the negative busbar second extension and ground.

The input terminal of the positive busbar may be formed with a first input terminal aperture, the input terminal of the negative busbar may be formed with a second input terminal aperture, and the functional elements of the input assembly may comprise a cover attached to the insulating housing, the cover being arranged on one side of the corresponding main body of the positive busbar and the negative busbar and opening upward above the corresponding input terminals of the positive busbar and the negative busbar and the bottom of the cover being formed with a set of openings respectively aligned with the first input terminal aperture and the second input terminal aperture.

The functional elements of the input assembly may comprise a cover-opening interlock device, the cover-opening interlock device comprising a female end disposed at the cover and a male end disposed at the housing cover of the power transfer unit, and the cover-opening interlock device is configured to disconnect the electrical connection between the stack and the set of busbars when the housing cover is opened.

The functional elements of the input assembly may comprise a voltage acquisition device arranged on the positive busbar adjacent to the stack and configured to acquire the output voltage of the stack.

The functional elements of the input assembly may comprise a cable management device disposed on the insulating housing and the cover, the cable management device comprising a ring structure for gathering the cables contained in the functional elements and a bending structure for guiding the cables.

The insulating housing may comprise a plurality of attachments configured to be detachably attached to the housing of the power transfer unit.

### BRIEF DESCRIPTION OF THE DRAWINGS

FIG. 1 shows a perspective view of an input assembly for a power transfer unit according to one example of the present disclosure;

FIG. 2 shows a perspective view of an input assembly for a power transfer unit according to the example of FIG. 1, wherein the cover in the input assembly is omitted;

FIG. 3 shows a perspective view of an input assembly for a power transfer unit according to the example of FIG. 1, viewed from another angle;

FIG. 4 shows a top view of an input assembly for a power transfer unit according to the example of FIG. 1; and

FIG. 5 shows a perspective view of a set of busbars of an input assembly for a power transfer unit according to one example of the present disclosure.

### DETAILED DESCRIPTION

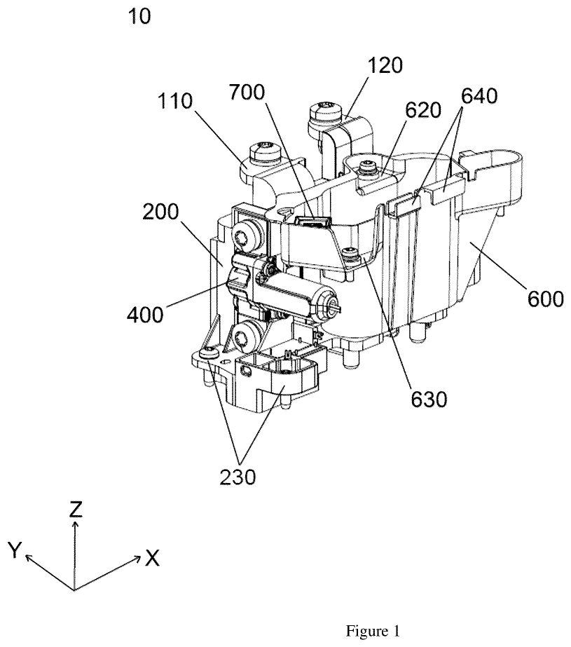

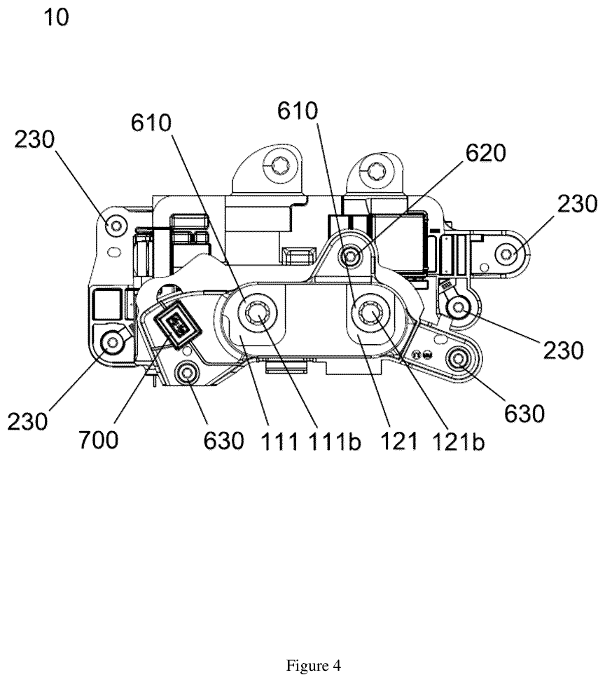

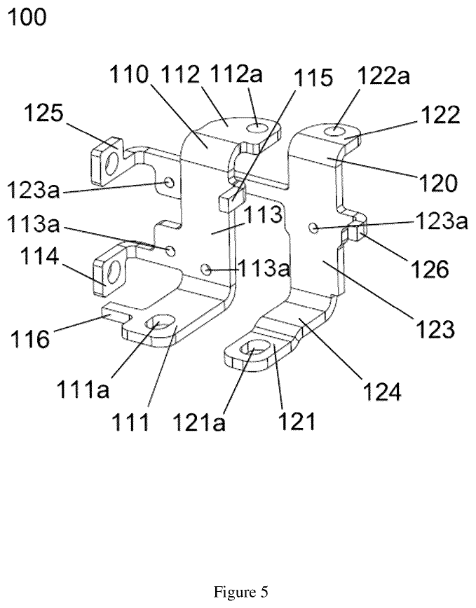

The input assembly for a power transfer unit (PTU) according to the present disclosure is described in detail below with reference to the accompanying drawings. FIGS. 1-3 show perspective views of the input assembly 10 for a power transfer unit according to one example of the present disclosure and FIG. 4 shows a top view of the input assembly 10 according to the example of FIG. 1. The input assembly 10 according to the present disclosure mainly comprises a set of busbars 100, and a perspective view of the set of busbars 100 is shown in FIG. 5. It should be noted that a reference coordinate system XYZ is shown in FIG. 1, where the X-axis represents the length direction or longitudinal direction, the Y-axis represents the width direction or transverse direction, and the Z-axis represents the height direction or vertical direction. The directions described in this article for each component all refer to this coordinate system.

Referring to FIG. 5, the set of busbars 100 comprises a positive busbar 110 and a negative busbar 120. The positive busbar 110 and the negative busbar 120 are made, for example, as copper busbars electrically connected between the fuel cell stack and the power transfer unit to transmit current from the fuel cell stack to the power transfer unit. Due to insulation requirements, a sufficient gap is provided between the positive busbar 110 and the negative busbar 120, and the two can be arranged to be parallel to each other.

As shown in FIG. 5, the positive busbar 110 comprises: an input terminal 111 electrically connected to the stack to receive current from the stack; an output terminal 112 electrically connected to the power transfer unit to transmit current to the power transfer unit; and a main body 113 located between the input terminal 111 and the output terminal 112. Similarly, the negative busbar 120 comprises: an input terminal 121 electrically connected to the fuel cell stack to receive current from the stack; an output terminal 122 electrically connected to the power transfer unit to transmit current to the power transfer unit; and a main body 123 located between the input terminal 121 and the output terminal 122.

As shown in FIGS. 1-4, the input assembly 10 comprises an insulating housing 200 that surrounds the main bodies 113 and 123 of the positive busbar 110 and the negative busbar 120 and at least partially fills the gap between the positive busbar 110 and the negative busbar 120. The insulating housing 200 can provide insulation between the positive busbar 110 and the negative busbar 120, and the insulating housing 200 can be used for positioning various functional elements of the input assembly 10, which will be described below.

FIG. 5 shows that the input terminal 111 and the output terminal 112 of the positive busbar 110 extend substantially vertically from its main body 113 in opposite directions, and the input terminal 121 and output terminal 122 of the negative busbar 120 extend substantially vertically from its main body 123 in opposite directions, thereby forming a structure with a substantially “Z” cross-section. This structure facilitates the electrical connection of the input terminal 111 of the positive busbar 110 and the input terminal 121 of the negative busbar 120 to the stack and facilitates the electrical connection of the output terminal 112 of the positive busbar 110 and the output terminal 122 of the negative busbar 120 to the power transfer unit.

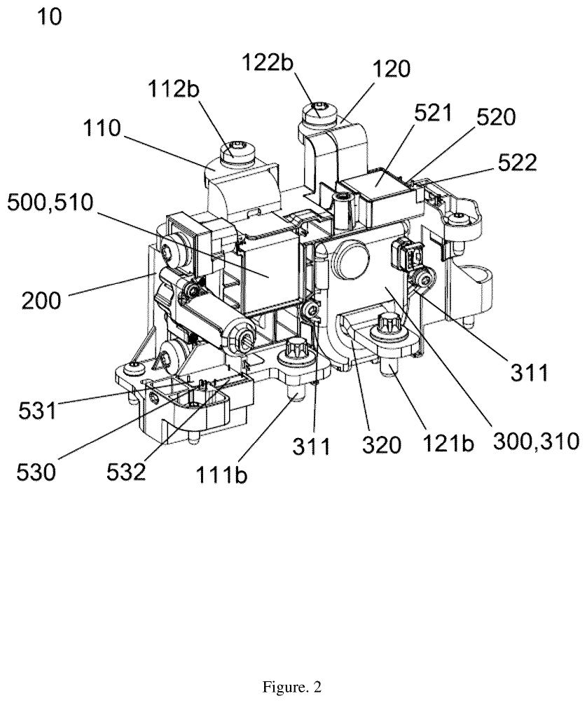

The input terminal 111 of the positive busbar 110 is formed with a through first input terminal aperture 111a, which is an oblong aperture as shown in FIG. 5. Although not shown in the figure, an output lead of the stack is arranged below the input terminal 111 of the positive busbar 110, e.g., in the form of a copper busbar, which is formed with an aperture designed to align with the input terminal aperture 111a of the input terminal 111 of the positive busbar 110. To electrically connect the input terminal 111 of the positive busbar 110 to the stack, a bolt can be passed through the input terminal aperture 111a of the input terminal 111 of the positive busbar 110 and the aperture of the output lead of the stack and a nut can be used to fix it below the output lead of the stack, thereby establishing an electrical connection between the input terminal 111 of the positive busbar 110 and the stack. Similarly, the input terminal 121 of the negative busbar 120 is formed with a through second input terminal aperture 121a that may likewise be formed as an oblong aperture. The bolts for electrical connection between the positive busbar 110 and the negative busbar 120 and the stack are indicated in FIG. 2 by reference numerals 111b and 121b. The connection between the negative busbar 120 and the stack is made in the same manner as that with the positive busbar 110 and will not be described again. The setting of the oblong apertures 111a and 121a allows for a certain degree of adjustable space in the positioning of the positive busbar 110 and the negative busbar 120 relative to the position of the stack.

The output terminal 112 of the positive busbar 110 is formed with a through first output terminal aperture 112a, which is a round aperture as shown in FIG. 5. Although not shown in the figure, an input lead of the power transfer unit is arranged below the output terminal 112 of the positive busbar 110, e.g., in the form of a copper busbar, which is formed with an aperture designed to align with the first output terminal aperture 112a of the output terminal 112 of the positive busbar 110. In order to electrically connect the output terminal 112 of the positive busbar 110 to the power transfer unit, a bolt can be passed through the first output terminal aperture 112a of the output terminal 112 of the positive busbar 110 and the aperture of the input lead of the power transfer unit and a nut can be used to fix it below the input lead of the power transfer unit, thereby establishing an electrical connection between the output terminal 112 of the positive busbar 110 and the power transfer unit. Similarly, the output terminal 122 of the negative busbar 120 is formed with a through second output terminal aperture 122a that may likewise be formed as a round aperture. The bolts for electrical connection between the positive busbar 110 and the negative busbar 120 and the power transfer unit are indicated in FIG. 2 by reference numerals 112b and 122b. The connection between the negative busbar 120 and the power transfer unit is made in the same manner as that with the positive busbar 110 and will not be described again.

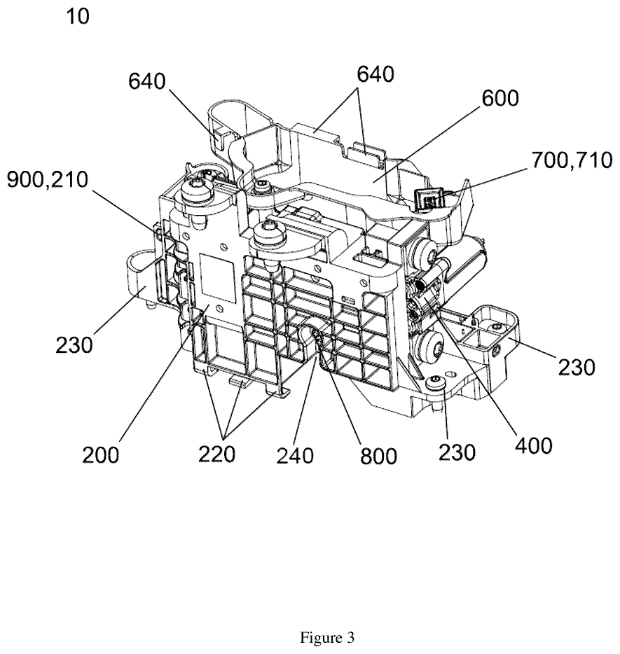

FIG. 5 further shows that the main bodies of the positive busbar 110 and the negative busbar 120 are respectively formed with a plurality of openings 113a and 123a (two openings are shown in FIG. 5, but it is not limited to this). These openings are positioning holes for the positive busbar 110 and the negative busbar 120 in the molding process of the insulating housing 200 and are formed as round openings, for example. The opening 113a above the transition between the main body 113 of the positive busbar 110 and the input terminal 111 further serves as an interface for fixing the voltage sampling device 800 (as shown in FIG. 3) described below. Specifically, a rivet nut may be fixed in the opening 113a and then a screw is used to engage the rivet nut by passing through a positioning hole on the voltage sampling device 800, thereby fixing the voltage sampling device 800 relative to the positive busbar 110.

In the input assembly 10 according to this example, the input assembly 10 further comprises a plurality of functional elements connected to the insulating housing 200 and/or the set of busbars 100. A conventional set of positive and negative busbars serving as the input assembly of the power transfer unit functions only to transmit current from the fuel cell stack to the power transfer unit. The space occupied by this set of busbars is usually underutilized. As power transfer units are designed to have more and more sub-components to achieve different functions, the applicants propose to integrate these sub-components with the set of busbars and the insulating housing to form an input assembly, that is, to use these sub-components as functional elements of the input assembly, thereby making full use of the space occupied by the set of busbars and realizing a compact input assembly for the power transfer unit.

Details of the arrangement of the various functional elements of the input assembly 10 relative to the insulting housing 200 and/or the set of busbars 100 will be described below in conjunction with FIGS. 1-4.

As shown in FIG. 2, the functional elements of the input assembly 10 may comprise a current sensor 300 for measuring the output current of the stack, which may be a commercially available current sensor, such as a fluxgate current sensor. The current sensor 300 is attached to the insulating housing 200 and comprises a sensor body 310 formed with a coil opening 320 and a coil for sensing current is arranged inside the sensor body 310 around the coil opening 320. The coil opening 320 is arranged adjacent to the stack and one of the positive busbar 110 and the negative busbar 120 passes through it, so that when current flows through the positive busbar 110 and the negative busbar 120, the coil undergoes electromagnetic induction to sense the magnitude of the current. The coil opening 320 of the current sensor 300 is arranged as close to the stack as possible to make the measurement of the output current of the stack more accurate.

The current sensor 300 is attached to the insulating housing 200. Specifically, the current sensor 300 may comprise a sensor mounting portion 311 intended to be attached to the insulating housing 200. The sensor mounting portion 311 may be in the form of lugs extending from both sides of the sensor body 310, as shown in FIG. 2. The current sensor 300 may be attached to the insulating housing 200 by way of screws passing through the sensor mounting portion 311.

Although the coil opening 320 of the current sensor 300 shown in FIG. 2 is arranged such that the negative busbar 120 passes through it, the present disclosure is not limited thereto, and the coil opening 320 may alternatively be arranged such that the positive busbar 110 passes through it. The current sensor 300 is arranged such that either the positive busbar 110 or the negative busbar 120 passes through its coil opening 320, depending on whether there is sufficient available space around the positive busbar 110 and the negative busbar 120.

As shown in FIG. 5, a step 124 is provided in the main body 123 of the corresponding busbar (shown as the negative busbar 120 in the figure) that passes through the coil opening 320 of the current sensor 300 in the set of busbars 100, near the input terminal 121 of the corresponding busbar. The step 124 is configured to protrude in a direction away from the stack (i.e., from bottom to top as shown in FIG. 5, which also corresponds to the Z-axis direction in FIG. 1), and the coil opening 320 of the current sensor 300 is arranged such that the step 124 passes through the coil opening 320. In conjunction with FIGS. 5 and 2, the step 124 is provided such that the bottom end of the current sensor 300 is “lifted” upward to some extent relative to the stack, thereby allowing the current sensor 300 to be arranged as close to the stack as possible without interfering with the electrical connection between the stack and the set of busbars 100 (specifically, the negative busbar 120). The height of the step 124 in the Z-axis direction depends on the size of the current sensor 200, in particular, the size of the bottom end of the current sensor 300 extending along the Z-axis from below the negative busbar 120. The height of the step 124 may be, e.g., in a range of 3-5 mm, e.g., 3.5 mm.

As previously described, bolts 111b and 121b are passed through the first input terminal aperture 111a of the input terminal 111 of the positive busbar 110 and the second input terminal aperture 121a of the input terminal 121 of the negative busbar 120, respectively, and the aperture of the output lead of the stack and are fixed with nuts below the output lead of the stack, thereby establishing electrical connections between the input terminal 111 of the positive busbar 110 and the input terminal 121 of the negative busbar 120 and the stack, respectively. In this case, since the bottom of the current sensor 300 is arranged below the negative busbar 120, it may cause interference with the arrangement of the output lead of the stack located below the negative busbar 120. In order to prevent such possible interference, the input terminal 121 of the negative busbar 120 may be made longer in the Y-axis direction shown in FIG. 1 so that the bottom of the current sensor 300 does not contact the output lead of the stack. However, this will increase the size of the negative busbar and thus increase the size of the entire input assembly in the width direction, i.e., the Y-axis direction shown in FIG. 1, resulting in the input assembly being insufficiently compact. The setting of the step 124 overcomes the above shortcomings, avoiding interference with the connection between the stack and the set of busbars 100 and reducing the size of the input assembly 10 in the width direction.

The input assembly 10 may further comprise a stack short-circuit protection device 400, which may be a commercially available PCD (power close device). The fuel cells mentioned in this article are typically used in electric vehicles. In the event of a collision, the fuel cell stack may be subjected to impacts such as compression. If the stack is still in operation, there may be a risk of explosion or fire. The working principle of the stack short-circuit protection device 400 is known in the art. Simply put, it is electrically connected between the positive busbar 110 and the negative busbar 120 and is configured to be in an open state when no collision event occurs with the electric vehicle. When a collision occurs, it receives a collision signal from the airbag of the electric vehicle. The collision signal triggers the stack short-circuit protection device 400 to switch to a closed state, causing a short circuit between the positive and negative poles of the stack and thereby avoiding the potential risks of explosion and fire.

In order to achieve installation of the stack short-circuit protection device 400 and its electrical connection with the positive busbar 110 and the negative busbar 120, as shown in FIG. 5, the positive busbar 110 comprises a positive busbar first extension 114 extending from the main body 113 thereof and the negative busbar 120 comprises a negative busbar first extension 125 extending from the main body 123 thereof. The positive busbar first extension 114 and the negative busbar first extension 125 may be formed with a flat mounting plate having an opening as shown in FIG. 5. The stack short-circuit protection device 400 is attached to the insulating housing 200 via the positive busbar first extension 114 and the negative busbar first extension 125 and is electrically connected between the positive busbar 110 and the negative busbar 120. Specifically, with reference to FIG. 5, rivet nuts can be fixed in the openings of the positive busbar first extension 114 and the negative busbar first extension 125, respectively. Referring further to FIG. 1, two screws can be used from one side of the input assembly 10 to pass through the positioning holes on the stack short-circuit protection device 400 and engage with the rivet nuts in the openings of the positive busbar first extension 114 and the negative busbar first extension 125, so that the stack short-circuit protection device 400 is positioned between the positive busbar 110 and the negative busbar 120 and electrically connected to the two.

It is to be noted that the structure and extension direction of the positive busbar first extension 114 and the negative busbar first extension 125 are not limited to the example shown in FIG. 5, but can be appropriately adjusted depending on the available space around the positive busbar 110 and the negative busbar 120 in the input assembly 10.

The input assembly 10 may further comprise an electromagnetic shielding device 500 configured to provide the required electromagnetic shielding between the stack and the power transfer unit. The electromagnetic shielding device 500 may be composed of commercially available capacitors used for electromagnetic shielding. Specifically, as shown in FIG. 2, the electromagnetic shielding device 500 comprises: an X capacitor 510 electrically connected between the positive busbar 110 and the negative busbar 120; a first set of Y capacitors 520 electrically connected between the positive busbar 110 and ground, comprising a first large Y capacitor 521 and a first small Y capacitor 522; and a second set of Y capacitors 530 electrically connected between the negative busbar 120 and the ground, comprising a second large Y capacitor 531 and a second small Y capacitor 532. The working principles of the various capacitors of the electromagnetic shielding device 500 are known in the art and therefore will not be described in detail.

The electromagnetic shielding device 500 can be installed by attaching it to the insulating housing 200 with the aid of potting compound. Specifically, as shown in FIG. 2, the insulating housing 200 is formed with a receiving chambers at the locations where the capacitors of the electromagnetic shielding device 500 are intended to be installed. The surfaces of these receiving chambers intended to contact the capacitors are coated with potting compound. The capacitors are then placed into the corresponding receiving chambers and fixed relative to the insulating housing 200 by way of the potting compound. In order to achieve the electrical connection and grounding of the electromagnetic shielding device 500 with the positive busbar 110 and the negative busbar 120, as shown in FIG. 5, the positive busbar 110 comprises a positive busbar second extension 115 extending from the main body 113 thereof and a positive busbar third extension 116 extending from the input terminal 111 thereof, and the negative busbar 120 comprises a negative busbar second extension 126 extending from the main body 123 thereof. The positive busbar second extension 115, the positive busbar third extension 116, and the negative busbar second extension 126 may each be provided with pins for electrical connection with a corresponding capacitor of the electromagnetic shielding device 500. Additionally, pins for electrical connection with the electromagnetic shielding device 500 may be provided on the insulating housing 200 at positions adjacent to the first set of Y capacitors 520 and the second set of Y capacitors 530, respectively. The X capacitor 510 is electrically connected between the positive busbar second extension 115 and the negative busbar 120. The first set of Y capacitors 520 is electrically connected between the positive busbar third extension 116 and ground. The second set of Y capacitors 530 is electrically connected between the negative busbar second extension 126 and ground. As such, the electromagnetic shielding device 500, which is composed of the X capacitor 510, the first set of Y capacitors 520, and the second set of Y capacitors 530, provides the required electromagnetic shielding between the stack and the power transfer unit.

The input assembly 10 may further comprise a cover 600 attached to the insulating housing 200. The cover 600 is made of insulating material, such as by injection molding. As shown in FIGS. 1, 3, and 4, the cover 600 is arranged on one side of the main bodies 113 and 123 of the positive busbar 110 and the negative busbar 120 and opens upward above the input terminals 111 and 121 of the positive busbar 110 and the negative busbar 120, respectively. The bottom of the cover 600 is formed with a set of openings 610 aligned with the first input terminal aperture 111a of the input terminal 111 of the positive busbar and the second input terminal aperture 121a of the input terminal 121 of the negative busbar, respectively. To electrically connect the input terminal 111 of the positive busbar 110 and the input terminal 121 of the negative busbar 120 to the stack, bolts can be used to pass through a set of openings 610 at the bottom of the cover 600 and through the input terminal aperture 111a of the input terminal 111 of the positive busbar 110 and the second input terminal aperture 121a of the input terminal 121 of the negative busbar aligned with the set of openings 610 and the aperture of the output lead of the stack and fixed with nuts below the output lead of the stack, thereby establishing an electrical connection between the input terminal 111 of the positive busbar 110 and the input terminal 121 of the negative busbar 120 and the stack. As shown in FIG. 1, the input assembly has a relatively large height dimension along the Z-axis. If the cover 600 is not provided, the bolts are likely to fall out in the narrow and deep operating space when the positive busbar 110 and the negative busbar 120 are electrically connected to the stack. Once they fall into the housing of the power transfer unit (not shown in the figure), they may be difficult to remove. The cover 600 prevents bolts from accidentally falling off, thus facilitating the assembly and maintenance of the input assembly.

FIG. 4 shows that the covers 600 further comprises a first fixing structure 620 intended for attachment to the insulating housing 200 and a second fixing structure 630 intended for attachment to the housing (not shown in the figure) of the power transfer unit. Two second fixing structures 630 are shown in FIG. 4. The first fixing structure 620 and the second fixing structure 630 can be fixed by screws. The position, shape, and quantity of the first fixing structure 620 and the second fixing structure 630 can be adjusted accordingly depending on the construction of the insulating housing 200 and the housing of the power transfer unit, respectively.

The input assembly 10 may further comprise a cover-opening interlock device 700 as shown in FIGS. 3 and 4. The cover-opening interlock device 700 comprises a female end 710 disposed at the cover 600 and a male end (not shown in the figure) disposed at the housing cover of the power transfer unit, and the cover-opening interlock device 700 is configured to disconnect the electrical connection between the stack and the set of busbars 100 when the housing cover of the power transfer unit is opened. The cover-opening interlock device 700 may employ commercially available connectors for cover-opening interlocking, and its function is known in the art. Simply put, the male and female ends of the cover-opening interlock device 700 may be connected to a PCB. When it detects that the housing cover of the power transfer unit is opened, it sends a signal to the PCB. Upon receiving the signal, the PCB can control the disconnection of the electrical connection between the stack and the set of busbars 100. When the housing cover of the power transfer unit is opened, the operator may access the busbars 100, e.g., if they need to perform the assembly between the busbars 100 and the stack. If the electrical connection between the stack and the busbars 100 is not disconnected at this time, there is a risk of electric shock during operation. By setting a cover-opening interlock device 700, the electrical connection between the stack and the busbars 100 will be automatically disconnected once the operator needs to open the casing of the power transfer unit for operation, thereby ensuring operational safety.

The input assembly 10 may further comprise a voltage acquisition device 800 arranged on the positive busbar 110 adjacent to the stack and configured to acquire the output voltage of the stack, as shown in FIG. 3. The voltage acquisition device 800 may be formed, e.g., as a metal ring, such as a copper ring, which is attached to the positive busbar 110 (as described above, by way of screws and rivet nuts) and is electrically connected to the PCB. When the voltage sampling connector on the PCB is working, the voltage value acquired at the voltage acquisition device 800 is sent to the PCB as the output voltage of the stack. As shown in FIG. 3, the insulating housing 200 is formed with an opening 240 at the location corresponding to the voltage acquisition device 800, which exposes the voltage acquisition device 800 such that the voltage acquisition device 800 can be fixed in the opening 240 by way of screws and corresponding rivet nuts in the positive busbar 110 to facilitate installation of the voltage acquisition device 800.

The input assembly 10 may further comprise a cable management device 900 disposed on the insulating housing 200 and the cover 600, as shown in FIG. 3. The cable management device 900 comprises a ring structure for gathering cables and a bending structure for guiding cables. The cables involved are those included in the functional elements of the input assembly 10, including cables of the current sensor 300 that transmit the current signal it senses, cables of the stack short-circuit protection device 400 that receive collision signals, cables of the cover-opening interlock device 700 that connect to the PCB, etc. The cable management device 900 facilitates the management of cables and facilitates operator access to the various components of the input assembly 10 for inspection and maintenance.

FIG. 3 shows that the periphery of the insulating housing 200 is provided with a ring structure 210 for gathering cables and a bending structure 220 for guiding cables. The bending structure 220 is formed as a plurality of L-shaped bending structures extending from the insulating housing 200, and the bending directions of adjacent L-shaped bending structures are opposite to achieve cable guidance and fixation. FIG. 3 further shows that the periphery of the cover 600, such as its top, has a plurality of similar bending structures 640. It should be noted that the arrangement and construction of the cable management device 900 can be adjusted according to the number and layout of the cables and is not limited to the forms shown in FIGS. 1 and 3.

The insulating housing 200 may comprise a plurality of attachments 230 configured to be detachably attached to the housing of the power transfer unit, as shown in FIGS. 3 and 4. Each attachment 230 comprises an opening through which the insulating housing 200 may be attached to the housing of the power transfer unit using screws. The entire input assembly 10 may be detachably attached to the housing of the power transfer unit by way of the plurality of attachments 230 of the insulating housing 200 and the two second fixing structures 630 of the cover 600. It should be noted that the number, positioning, and construction of the attachments 230 of the insulating housing 200 may be adjusted accordingly depending on the construction of the housing of the power transfer unit and are not limited to the forms shown in FIGS. 1-4.

The above description, in conjunction with the figures, details the input assembly 10 for a power transfer unit according to the present disclosure. The input assembly 10 has a compact structure. In particular, in the XYZ coordinate axis shown in FIG. 1, the input assembly 10 has a length of about 200 mm, a width of about 100 mm, and a height of about 120 mm. The input assembly 10 provides the plurality of functions described above in a compact structure, realizing advantages such as saving space and easy assembly and maintenance.

It should be noted that FIGS. 1-5 show only one example of the input assembly for a power transfer unit according to the present disclosure. However, the arrangement of the various components of the input assembly may be modified as appropriate. For example, as previously noted, the current sensor 300 is shown arranged such that the negative busbar 120 passes through its coil opening 320, but in alternative examples, it is also feasible to arrange it so that the positive busbar 110 passes through its coil opening 320. In this alternative embodiment, the arrangement of other functional elements of the input assembly 10 also needs to be adjusted accordingly as the arrangement of the current sensor 300 is adjusted. Appropriate adjustments to the arrangement of the functional elements of the input assembly 10 should be considered as falling within the scope of the present disclosure.

The above description, with reference to the accompanying drawings, details feasible but non-limiting embodiments of the input assembly for a power transfer unit according to the present disclosure. For those of ordinary skilled in the art, without deviating from the scope and substance of the present disclosure as set forth in the claims below, modifications and additions to techniques and structures and recombinations of features in various examples shall obviously be deemed to be included within the scope of the present disclosure. As a result, these modifications and supplements that may be conceived under the guidance of the present disclosure shall be considered as a part of the present disclosure. The scope of the present disclosure is defined by the appended patent claims below and comprises equivalent technologies known at the time of filing of the present disclosure, as well as unforeseen equivalent technologies.

What is claimed is:

1. An input assembly for a power transfer unit, comprising:
a set of busbars comprising a positive busbar and a negative busbar, each of the positive busbar and the negative busbar comprising an input terminal electrically connected to a fuel cell stack to receive current from the stack, an output terminal electrically connected to the power transfer unit to transmit current to the power transfer unit, and a main body located between the corresponding input terminal and output terminal; and
an insulating housing that surrounds the corresponding main body of the positive busbar and the negative busbar and at least partially fills the gap between the positive busbar and the negative busbar,
wherein functional elements of the input assembly are connected to the insulating housing and/or the set of busbars.

2. The input assembly according to claim 1, wherein the functional elements of the input assembly comprise a current sensor attached to the insulating housing and configured to measure the output current of the stack, the current sensor comprising a sensor body formed with a coil opening and a coil configured to sense current being arranged inside the sensor body around the coil opening, and wherein the coil opening is arranged adjacent to the stack and one of the positive busbar and the negative busbar passes through the coil opening.

3. The input assembly according to claim 2, wherein a step is provided in the main body of the corresponding busbar passing through the coil opening in the set of busbars near the input terminal of the corresponding busbar, the step being configured to protrude in a direction away from the stack and the coil opening being arranged such that the step passes through the coil opening.

4. The input assembly according to claim 1, wherein:
the positive busbar comprises a positive busbar first extension extending from the main body thereof, the negative busbar comprises a negative busbar first extension extending from the main body thereof, and
the functional elements of the input assembly comprise a stack short-circuit protection device, the stack short-circuit protection device being attached to the insulating housing and electrically connected between the positive busbar and the negative busbar via the positive busbar first extension and the negative busbar first extension.

5. The input assembly according to claim 1, wherein the positive busbar comprises a positive busbar second extension extending from the main body thereof and a positive busbar third extension extending from the input terminal thereof, the negative busbar comprises a negative busbar second extension extending from the main body thereof, and
the functional elements of the input assembly comprise an electromagnetic shielding device, the electromagnetic shielding device comprising an X capacitor electrically connected between the positive busbar second extension and the negative busbar, a first set of Y capacitors electrically connected between the positive busbar third extension and ground, and a second set of Y capacitors electrically connected between the negative busbar second extension and ground.

6. The input assembly according to claim 1, wherein:
the input terminal of the positive busbar is formed with a first input terminal aperture, the input terminal of the negative busbar is formed with a second input terminal aperture, and
the functional elements of the input assembly comprise a cover attached to the insulating housing, the cover being arranged on one side of the corresponding main body of the positive busbar and the negative busbar and opening upward above the corresponding input terminals of the positive busbar and the negative busbar and the bottom of the cover being formed with a set of openings respectively aligned with the first input terminal aperture and the second input terminal aperture.

7. The input assembly according to claim 6, wherein the functional elements of the input assembly comprise a cover-opening interlock device, the cover-opening interlock device comprising a female end disposed at the cover and a male end disposed at the housing cover of the power transfer unit, and the cover-opening interlock device is configured to disconnect the electrical connection between the stack and the set of busbars when the housing cover is opened.

8. The input assembly according to claim 1, wherein the functional elements of the input assembly comprise a voltage acquisition device arranged on the positive busbar adjacent to the stack and configured to acquire the output voltage of the stack.

9. The input assembly according to claim 6, wherein the functional elements of the input assembly comprise a cable management device disposed on the insulating housing and the cover, the cable management device comprising a ring structure for gathering the cables contained in the functional elements and a bending structure for guiding the cables.

10. The input assembly according to claim 1, wherein the insulating housing comprises a plurality of attachments configured to be detachably attached to the housing of the power transfer unit.
